(19) United States
(12) Patent Application Publication
(10) Pub. No.: US 2026/0322153 A1
(43) Pub. Date: Oct. 15, 2026

(54) Capacitor Charging Module, Airbag Controller, and Airbag System

(71) Applicant: Robert Bosch GmbH, Stuttgart (DE)

(72) Inventor: Xiaofei Qiu, Suzhou (CN)

(21) Appl. No.: 19/647,572

(22) Filed: Apr. 14, 2026

(30) Foreign Application Priority Data
Apr. 15, 2025 (CN) 2025 1047 1091.5

(51) Int. Cl. H02J 7/90; B60R 16/03; B60R 21/01

(52) U.S. Cl. CPC H02J 7/933; B60R 16/03; B60R 21/01; H02J 2207/20; H02J 2207/50

(57) ABSTRACT

A capacitor charging module includes a voltage converter, a voltage divider module, a current adjustment module, and a power end comparison module. The voltage divider module electrically couples the output end of the voltage converter to obtain a first feedback signal and a second feedback signal for reflecting the output voltage of the voltage converter. The current adjustment module compares the first feedback signal and the first reference signal, and increases the charging current of the energy reserve capacitor in the charging mode if the first feedback signal is greater than the first reference signal, and stops increasing the charging current of the energy reserve capacitor in the charging mode if the first feedback signal is less than the first reference signal. The power end comparison module receives the second reference signal and outputs a control signal for controlling the charging power output based on a comparison of the second reference signal and the second feedback signal. An airbag controller and an airbag system are also disclosed.

This application claims priority under 35 U.S.C. § 119 to application no. CN 2025 1047 1091.5, filed on Apr. 15, 2025 in China, the disclosure of which is incorporated herein by reference in its entirety.

The present application relates to charging techniques, and more particularly, to charging techniques that may be used for airbag controllers in a vehicle.

### BACKGROUND

An airbag (Air Bag, AB) control system needs to reserve sufficient energy, i.e., to reserve sufficient energy in the Energy Reserve Capacitor (ER) with a large capacitance. When designing the airbag controller chipset, setting the charging current for the energy reserve capacitor is critical.

FIG. 1 is a structural schematic diagram of a charging module for charging an energy reserve capacitor in an application-specific integrated circuit (ASIC). As shown in FIG. 1, a charging module 2 of the ASIC receives power 10 from a power source, and a boost converter 20 receives the power 10 and converts it into power with a voltage of Vup. The power with a voltage of Vup is transmitted to a current source adjuster 22 electrically connected to the energy reserve capacitor ERC to thereby charge the energy reserve capacitor ERC. During the charging process, the output current of the charging module of the ASIC shall be less than its maximum performance current, e.g., less than the rated current of the boost converter 20. However, in the initial stage of charging, if the charging current of the energy reserve capacitor is large, resulting in a maximum performance current that is nearly equal to or greater than the ASIC charging module, this may lead to the device of ASIC overheating, causing circuit anomalies or damage. During design processes of airbags for example, the charging current of the energy reserve capacitor is typically limited to a smaller value that is used to ensure that the ASIC charging module, or otherwise, is used to ensure normal operation of the ASIC, but this can lead to excessive charging times. On the other hand, if the ASIC adopted changes, the charging current of the energy reserve capacitor ERC has to be redefined, increasing the workload.

In view of the above problems, it is urgent to improve the existing techniques to optimize the charging design of the energy reserve capacitor and improve the performance and reliability of the airbag system.

### SUMMARY

According to one aspect of the present application, a capacitor charging module is provided, and the charging module may include a voltage converter for converting an input voltage to an output voltage; a voltage divider module, electrically coupling an output end of the voltage converter to obtain a first feedback signal and a second feedback signal reflecting the output voltage of the voltage converter; a current adjustment module for comparing the first feedback signal and a first reference signal, and in the case where the first feedback signal is greater than the first reference signal, increasing a charging current of the energy reserve capacitor in a charging mode, and when the first feedback signal is less than the first reference signal, preventing further increase of the charging current of the energy reserve capacitor in the charging mode; a power end comparison module, for receiving a second reference signal and based on a comparison of the second reference signal and the second feedback signal, outputting a control signal for controlling the charging power output.

Optionally, or by way of example, in the charging module, the voltage divider module may comprise a first voltage divider unit, an input end of the first voltage divider unit connecting an output end of the charging power; a second voltage divider unit, an input end of the second voltage divider unit connecting an output end of the first voltage divider unit; a third voltage divider unit, an input end of the third voltage divider unit connecting an output end of the second voltage divider unit; and the first feedback signal is collected from a connection between the second voltage divider unit and the third voltage divider unit, the second feedback signal is collected from a connection between the first voltage divider unit and the second voltage divider unit, and the first voltage divider unit, the second voltage divider unit, and the third voltage divider unit are set so that a voltage represented by the first feedback signal is greater than a voltage represented by the second feedback signal.

Optionally, or by way of example, in the charging module, the first voltage divider unit, the second voltage divider unit, and the third voltage divider unit are respectively resistors.

Optionally, or by way of example, in the charging module, the current adjustment module includes: a first comparator, an input end of which receives the first feedback signal and the first reference signal; a driver, an input end of which connects to an output end of the adjustment end comparator to adjust the charging current according to the output signal.

Optionally, or by way of example, in the charging module, the first feedback signal is fed to an inverting end of the first comparator and the first reference signal is fed to a non-inverting end of the first comparator.

Optionally, or by way of example, in the charging module, the first feedback signal and the first reference signal are both voltage signals or current signals; the second feedback signal and the first reference signal are both voltage signals or current signals.

Optionally, or by way of example, in the charging module, the voltage converter is a boost converter.

Optionally, or by way of example, in the charging module, the first reference signal and the second reference signal are the same.

Also provided is an airbag controller configured with an energy reserve capacitor, and the airbag controller is provided with any one of the charging modules described above.

Also provided is an airbag system that includes an airbag, a gas generator, and the airbag controller as described herein.

### BRIEF DESCRIPTION OF THE DRAWINGS

The present application will be more fully understood by referring to the detailed description of the specific embodiments below in conjunction with the drawings, in which the same reference numerals in the drawings refer to the same elements, wherein:

FIG. 1 is a structural schematic diagram of an application-specific integrated circuit (ASIC) charging an energy reserve capacitor;

FIG. 2 illustrates a structural diagram of a capacitor charging module, according to some embodiments of the present application;

FIG. 3 is a structural diagram of a capacitor charging module according to some specific embodiments of the present application;

FIG. 4 illustrates the charging performance of an application-specific integrated circuit ASIC, with the horizontal axis representing the voltage VBAT applied to the boost converter and the vertical axis representing the charging performance of the ASIC.

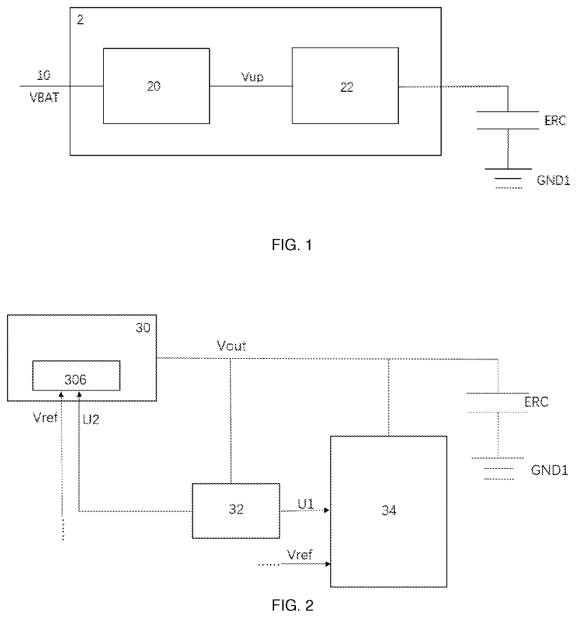

### DETAILED DESCRIPTION

In order to make the object, technical solution, and advantages of the embodiments of the present application more clear, the embodiments of the present application will be clearly and completely described below in conjunction with the attached drawings. It is to be noted that the embodiments described are only a part, rather than all, of the embodiments of the technical solution of the present application. All other embodiments obtained by those of ordinary skill in the art without creative effort based on the embodiments documented in the present application are covered by the scope of protection of the present application.

Typically, the charging current during the capacitor charging process increases first, then decreases until the charging current is zero, and accordingly, the capacitor voltage increases from a small value until it equals the charging voltage.

FIG. 2 illustrates a structural diagram of a capacitor charging module, according to some embodiments of the present application. By way of example, the charging module may be disposed in an ASIC, such as an ASIC of an airbag control system, as a charging module charging to an energy reserve capacitor.

As shown in FIG. 2, the charging module includes a boost converter 30, a voltage divider module 32, a current adjustment module 34, and a power end comparison module 306. The voltage divider module 32 electrically connects an output end of the boost converter 30 to obtain a first feedback signal U1 and a second feedback signal U2 for reflecting an output voltage Vout of the boost converter 30. The boost converter 30 is used to receive an input voltage to convert the input voltage to an output voltage of the output end. The current adjustment module 34 compares the first feedback signal U1 and a first reference signal. In the case where the first feedback signal U1 is greater than the first reference signal, the current adjustment module 34 increases the charging current of the energy reserve capacitor ERC in a charging mode, and prevents further increase in the charging current of the energy reserve capacitor in the charging mode when the first feedback signal U1 is less than the first reference signal. The power end comparison module 306 receives a second reference signal and outputs a control signal for controlling the output of the boost converter 30 based on the comparison results of the second reference signal and the second feedback signal U2.

The first feedback signal, the first reference signal, the second feedback signal, and the second reference signal may be signals representing voltage (may be referred to as voltage signals) or signals representing current (may be referred to as current signals). In an example of the present application, the first feedback signal, the first reference signal, the second feedback signal, and the second reference signal are all voltage signals. Further, the first reference signal and the second reference signal may be the same or different, and may be specifically set in advance. In each example of the present application, the first reference signal and the second reference signal are the same signal, specifically representing voltage Vref.

When charging to the energy reserve capacitor by the exemplary charging module of the present application, the current adjustment module 34 may adaptively adjust the charging current input into the energy reserve capacitor ERC based on the comparison results of the first feedback signal U1 and the first reference signal. For example, the output voltage Vout of the boost converter 30 is 33 volts and the voltage of the reference signal is 2.5 volts. According to the example of the present application, as long as the voltage represented by the first feedback signal U1 collected by the voltage divider module 32 is greater than the voltage of the first reference signal (also referred to herein simply as a reference voltage), i.e., greater than 2.5 volts, the current adjustment module 34 may increase the charging current in the charging mode. During this period, even if the output voltage Vout of the boost converter 30 changes, as long as the first feedback signal U1 is not reduced below the reference voltage due to the change in the output voltage Vout, the charging current may be increased to charge the energy reserve capacitor more quickly.

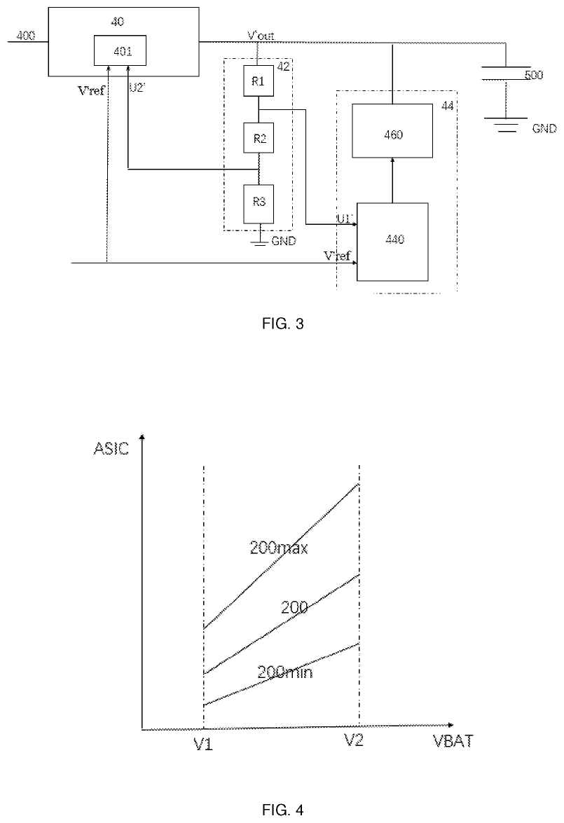

FIG. 3 is a structural diagram of a capacitor charging module according to some specific embodiments of the present application, and the charging module in this example may be applied to an ASIC in a vehicle airbag control system for charging an energy reserve capacitor 500 of the airbag control system.

Referring to FIG. 3, the charging module includes a boost converter 40 that receives an input power 400, a voltage divider module 42, and a current adjustment module 44. The voltage divider module 42 includes a first voltage divider unit, a second voltage divider unit, and a third voltage divider unit. The input end of the first voltage divider unit connects to the output end of the boost converter 40, and the output end of the first voltage divider unit connects to the input end of the second voltage divider unit. The output end of the second voltage divider unit connects to the input end of the third voltage divider unit. The first voltage divider unit and the second voltage divider unit cooperate with the third voltage divider unit to distribute the voltage Vout in a certain ratio to obtain the required voltage. According to the example of the present application, the first feedback signal U1 is collected between the first voltage divider unit and the second voltage divider unit, and the second feedback signal U2 is collected between the second voltage divider unit and the third voltage divider unit. The first, second, and third voltage divider units are configured so that the voltage represented by the first feedback signal U1′ is greater than the voltage represented by the second feedback signal U2′.

By way of example and not limitation, the first voltage divider unit adopts a voltage divider resistor R1, the second voltage divider unit adopts a voltage divider resistor R2, and the third voltage divider unit adopts a voltage divider resistor R3. In some examples, the resistance value of the voltage divider resistor R1 is greater than the resistance value of the voltage divider resistor R2, and the resistance value of the voltage divider resistor R2 is greater than the resistance value of the voltage divider resistor R3. Or, the sum of the resistances of the voltage divider resistor R2 and the voltage divider resistor R3 is greater than the resistance of the voltage divider resistor R3. The above configuration causes the voltage represented by the first feedback signal U1′ to be greater than the voltage represented by the second feedback signal U2′.

The current adjustment module 44 includes a first comparator 440, and a driver 460. The first feedback signal U1′ is transmitted to the comparator 440 and the second feedback signal U2′ is transmitted to the power supply end comparison module 401. In particular, the power end comparison module 401 is a comparator, which is referred to directly below as the power end comparator 401. In a specific example, the first feedback signal U1′ is fed to the inverting end of the first comparator 440, the reference signal V′ref is fed to the non-inverting end of the first comparator 440; the second feedback signal U2′ is fed to the inverting end of the power end comparator 401, and the reference signal V′ref is fed to the non-inverting end of the power end comparator 401.

The power end comparator 401 is part of the pulse width modulation signal PWM generation module of the boost converter 40. The power end comparator 401 generates a control signal based on the comparison result of the second feedback signal U2′ and the reference signal V′ref, and the control signal controls the output of the boost converter 40 after being processed by duty cycle control, etc., The output voltage of the boost converter 40 is decreased, and the voltage represented by the second feedback signal U2′ is decreased accordingly. If the decrease in the output voltage causes the second feedback signal U2′ to be less than the reference signal V′ref, then the boost converter 40 enters a maximum electrical power output mode. In the maximum electrical power output mode, the output current Iout increases when the output voltage V′out of the boost converter 40 decreases. In this example, the comparison of the feedback signal to the reference signal is a comparison of the voltage represented by the feedback signal to the voltage represented by the reference signal. As mentioned above, the reference signal is also referred to as a reference voltage.

The first comparator 440 of the current adjustment module 44 compares the first feedback signal U1′ to a reference signal. When the first feedback signal U1′ is greater than the reference voltage V′ref, the output signal of the first comparator 440 will cause the driver 460 to increase the charging current during the charging current increase phase. For example, the output voltage of the boost converter 40 is Vout1, and the output current corresponding thereto is Iout1. At this time, the first feedback signal U1′ represents a voltage greater than the reference voltage V′ref, so the current adjustment module 44 increases the charging current that charges the energy reserve capacitor 500 until the first feedback signal U1′ is less than the reference voltage V′ref.

FIG. 4 illustrates the charging performance of an application-specific integrated circuit (ASIC), with the horizontal axis representing the voltage VBAT applied to the boost converter, the vertical axis representing the charging performance of the ASIC, the maximum performance output current expressed as line 200 max, and the minimum performance output current expressed as line 200 min. In the case of conventional charging modules, to ensure that the output current of the charging power supply during charging does not exceed the limit of the boost converter's own output current, the charging current of the energy reserve capacitor is generally set to a midpoint that is generally equal to the ASIC maximum performance current and the minimum performance current value, as shown by line 200 in the figure.

With the charging module according to the example of the present application, the current adjustment module, based on the comparison of the first reference signal and the first feedback signal, adaptively increases the charging current during the charging process increase phase of the charging process without considering relevant output characteristics such as the output voltage change, thereby allowing the energy reserve capacitor ERC to charge faster. In this way, the charging current can be brought as close as possible to the maximum performance current of the ASIC without exceeding it.

Referring to FIG. 3, when the voltage input to the boost converter 40 is 6 V, the output voltage of the boost converter 40 is, for example, 33 volts, and the maximum performance current of the ASIC is Imax. In the process of charging the energy reserve capacitor 500, the first feedback signal U1′ is greater than the reference voltage of 2.5 volts, so the current adjustment module 44 will increase the charging current of the energy reserve capacitor 500, for example, to 90% of the Imax. During the charging process, if the ASIC including the boost converter 40 decreases the output voltage for some reason, for example to 30 volts, the first feedback signal U1′ and the second feedback signal U2′, both representing voltages, decrease, and if the first feedback signal U1′ decreases to less than the reference signal, the output of the first comparator 440 causes the current adjustment module 44 to no longer increase the charging current. When the output voltage decreases more so that the second feedback signal U2′ is also less than the voltage represented by the reference signal (i.e., the reference voltage), the output of the power end comparator 401 will cause the boost conversion module 40 to operate in the maximum electrical power mode, and the output current will increase due to the output voltage reduction and may increase to Imax. However, since the first feedback signal U1′ is less than the reference signal V′ref before the second feedback signal U2′, the current adjustment module has already stopped increasing the current used to charge the energy reserve capacitor 500. Therefore, even though the output current of the boost converter increases and may reach the maximum performance current Imax, the charging current is no longer increased under the control of the current adjustment module. Accordingly, this allows for a relatively large current to be used to charge the energy reserve capacitor 500, thereby increasing the charging speed, while also ensuring that the charging current does not reach the maximum performance current.

Further, if the ASIC module changes, for example, its maximum performance current increases, for example, greater than Imax6 in the aforementioned example, when the exemplary charging module according to the present application is employed, there is no need to adjust the charging current charged to the energy reserve capacitor. The first comparator 440 may increase the charging current and stop increasing the charging current based on a comparison of the first feedback signal and the reference signal.

According to an example of the present application, an airbag controller is also provided. The airbag controller includes any of the charging modules described above. According to an example of the present application, an airbag system is also provided. The airbag system includes the airbag controller, or includes any of the charging modules described above.

Further, in the above examples of the present application, the voltage converter is a boost converter. However, in other application scenarios, the voltage converter may be a buck converter. For example, when the input voltage is high, the voltage converter converts it to a lower voltage.

The technical features in the various embodiments of the present application may be combined to form a new embodiment without departing from the spirit of the present application and without conflicting with one another. While specific examples of the present application have been shown and described in detail to illustrate the principles of the present application, it will be appreciated that the present application may be implemented in other ways without departing from such principles.

What is claimed is:

1. A capacitor charging module, comprising:
a voltage converter configured to convert an input voltage to an output voltage;
a voltage divider module electrically connecting an output end of the voltage converter to obtain a first feedback signal and a second feedback signal for reflecting the output voltage of the voltage converter;
a current adjustment module configured to compare the first feedback signal and a first reference signal, and increase the charging current of the energy reserve capacitor in a charging mode if the first feedback signal is greater than the first reference signal, and cause the charging current of the energy reserve capacitor in the charging mode to no longer increase if the first feedback signal is less than the first reference signal; and
a power end comparison module that is configured to receive a second reference signal and output a control signal to control the output of the charging power based on a comparison of the second reference signal and the second feedback signal.

2. The charging module according to claim 1, wherein the voltage divider module comprises:
a first voltage divider unit, an input end of the first voltage divider unit being connected to an output end of the charging power;
a second voltage divider unit, an input end of the second voltage divider unit being connected to an output end of the first voltage divider unit; and
a third voltage divider unit, an input end of the third voltage divider unit being connected to an output end of the second voltage divider unit,
wherein the first feedback signal is collected from a connection of the first voltage divider unit and the second voltage divider unit,
wherein the second feedback signal is collected from a connection of the first voltage divider unit and the second voltage divider unit, and
wherein the first voltage divider unit, the second voltage divider unit, and the third voltage divider unit are set so that the voltage represented by the first feedback signal is greater than the voltage represented by the second feedback signal.

3. The charging module according to claim 2, wherein the first voltage divider unit, the second voltage divider unit, and the third voltage divider unit are respectively resistors.

4. The charging module according to claim 1, wherein the current adjustment module comprises:
a first comparator, an input end of which receives the first feedback signal and the first reference signal; and
a driver, an input end of which is coupled to an output end of the adjustment end comparator to adjust the charging current according to the output end signal.

5. The charging module according to claim 4, wherein the first feedback signal is fed to an inverting end of the first comparator and the first reference signal is fed to a non-inverting end of the first comparator.

6. The charging module according to claim 1, wherein the first feedback signal and the first reference signal are both voltage signals or current signals, and wherein the second feedback signal and the first reference signal are both voltage signals or current signals.

7. The charging module according to claim 1, wherein the voltage converter is a boost converter.

8. The charging module according to claim 1, wherein the first reference signal and the second reference signal are the same.

9. An airbag controller configured with an energy reserve capacitor, wherein the airbag controller comprises the charging module according to claim 1.

10. An airbag system, comprising an airbag, a gas generator, and the airbag controller according to claim 9.
